(19) United States
(12) Patent Application Publication
(10) Pub. No.: US 2006/0082213 A1
(43) Pub. Date: Apr. 20, 2006

(54) Vehicle wheel having a reflecting rim

(76) Inventor: Mark Tirado, Huntington Beach, CA (US)

Correspondence Address: CHRISTIE, PARKER & HALE, LLP, PO BOX 7068, PASADENA, CA, 91109-7068, US

(21) Appl. No.: 10/964,962

(22) Filed: Oct. 14, 2004

(51) Int. Cl. B60B 7/00

(52) U.S. Cl. 301/37.109

(57) ABSTRACT

A vehicle wheel is provided that includes an image receiving area defined by a first surface of the wheel; and an image reflecting area defined by a second surface of the wheel that is disposed in close proximity to the image receiving area, wherein the image receiving area includes an image that is reflected by the image reflecting area into a line of sight of a viewer.

### FIELD OF THE INVENTION

The present invention relates to a vehicle wheel and more particularly to a vehicle wheel having a first surface area with an image defined thereon and a second surface area that reflects the image to a line of sight of a viewer

### BACKGROUND

A growing trend in many motor vehicle industries is to produce wheels that are aesthetically pleasing. Various wheels have been introduced to accomplish this goal, such as wheels having unique spoke designs, unique color schemes and finishes, and other artistic designs.

### SUMMARY

In an exemplary embodiment of the present invention, a vehicle wheel is provided that includes an image receiving area defined by a first surface of the wheel; and an image reflecting area defined by a second surface of the wheel that is disposed in close proximity to the image receiving area. The image receiving area is intended to receive an image that is reflected by the image reflecting area into a line of sight of a viewer to provide an aesthetically pleasing visual effect.

In another exemplary embodiment of the present invention, a vehicle wheel is provided that includes at least one spoke and a removable insert attached to the at least one spoke, wherein the insert comprises an image receiving area to which an image may be affixed. An image reflecting area is disposed in close proximity to the image receiving area, wherein the image reflecting area reflects the image into a line of sight of a viewer.

### BRIEF DESCRIPTION OF THE DRAWINGS

Novel features in exemplary embodiments of the present invention will be better understood by reference to the following detailed description when considered in conjunction with the accompanying drawings wherein:

FIG. 1 is a perspective view of a vehicle wheel according to an exemplary embodiment of the present invention;

FIG. 2 is a partially exploded perspective view of a portion of the vehicle wheel of FIG. 1;

FIG. 3 is a cross-sectional view of the vehicle wheel taken from line 3-3 of FIG. 1;

FIG. 4A is a perspective view of the vehicle wheel of FIG. 1 as viewed slightly offset from a side view of the wheel;

FIG. 4B is another perspective view of the vehicle wheel of FIG. 1 as viewed slightly offset from a front view of the wheel; and

FIG. 5 is a front view of the vehicle wheel of FIG. 1.

### DETAILED DESCRIPTION

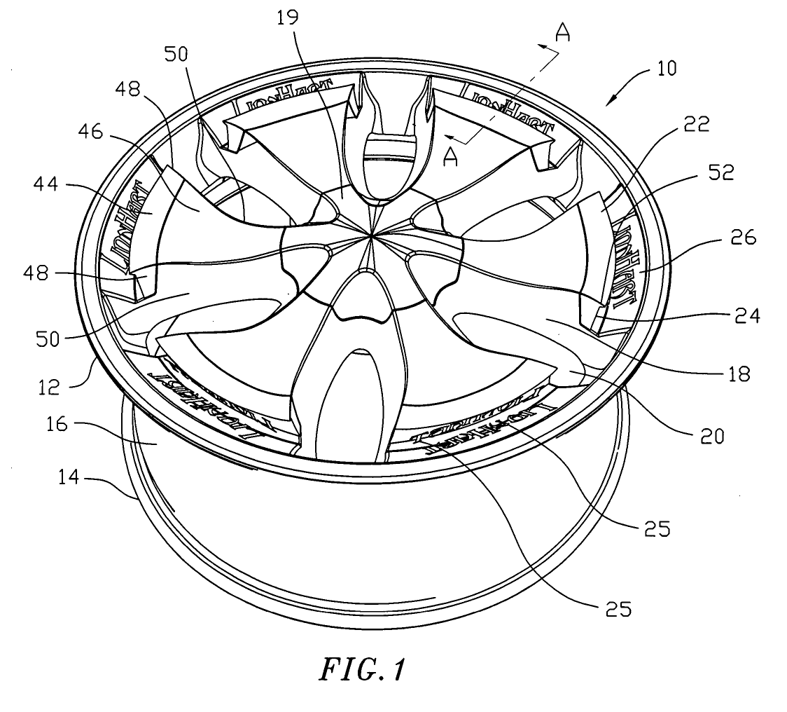

As shown in FIGS. 1-5, the present invention is directed to a vehicle wheel having a first surface area to which an image may be affixed, or upon which an image may be defined. The vehicle wheel further includes a second surface area that reflects the image to a line of sight of a viewer. In one embodiment, the first surface area is disposed at a predetermined distance from the second surface area and at a predetermined angle with respect to the second surface area to optimize the visual effect that is viewed along the line of sight of the viewer.

FIG. 1 shows a vehicle wheel according to an exemplary embodiment of the present invention. In this embodiment, the wheel is an automobile wheel 10. As shown, the automobile wheel 10 is substantially cylindrical having a first side 12 that faces outwardly or away from an automobile (not shown) when the wheel 10 is attached to a wheel axle of the automobile; a second side 14 that faces inwardly or toward the automobile; and an intermediate area 16 that receives a tire (not shown).

As is also shown in FIG. 1, the first side 12 of the wheel 10 includes a plurality of spokes 18 having one or more spoke openings 20 between each adjacent pair of spokes 18. Each spoke 18 extends toward a center or hub of the wheel 10 and terminates adjacent to a removable hub cap 19. The hub cap 19 may be removed from the wheel 10 by methods commonly know in the art. When so attached, the hub cap 19 covers the lug openings (not shown) used to connect the wheel 10 to an automobile wheel axle via lug nuts.

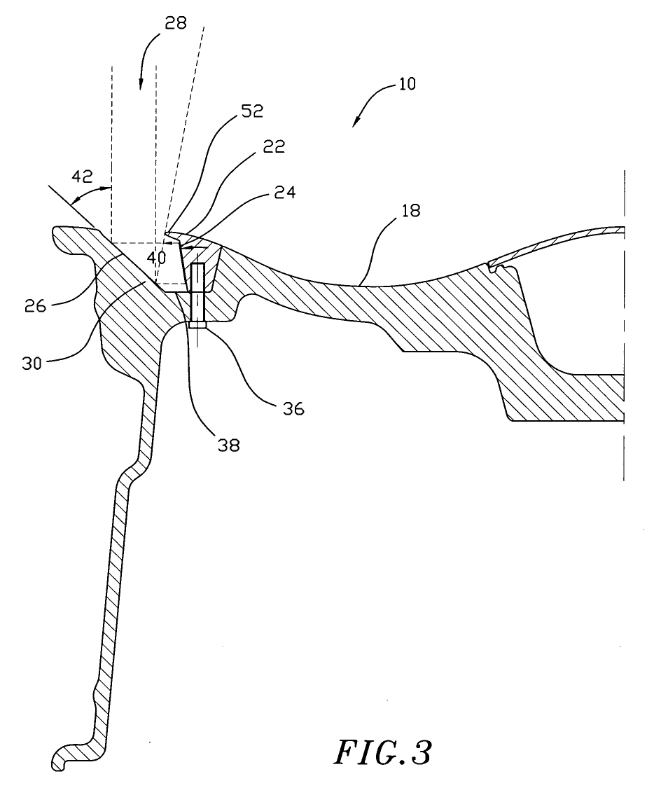

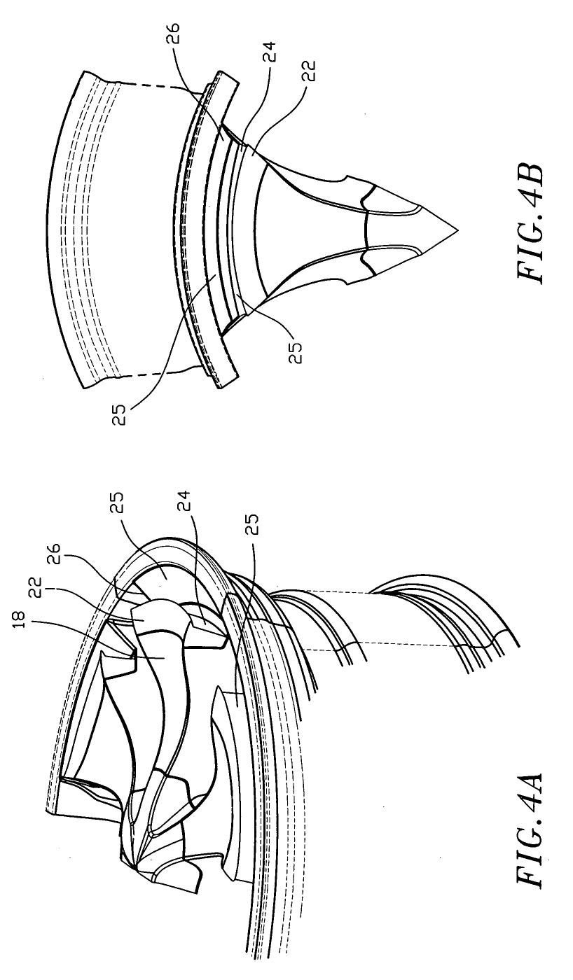

In one embodiment, such as that shown in FIG. 1, an insert 22 is attached to each spoke 18. Each insert 22, in turn, includes the above described first surface area or an image receiving area 24 that receives an image 25 (see also FIGS. 4A-4B for clarity). The insert 22 is positioned in proximity to the above described second surface area or an image reflecting area 26 that reflects the image 25 to a line of sight 28 (as shown in FIG. 3) of a viewer. In general, the line of sight represents the line along which the reflected image may be clearly seen by one viewing the wheel. In one embodiment, the line of sight is such that a person viewing the wheel sees only a portion of the reflected image, or for example, where multiple reflected images are provided from different portions of the wheel such as from different spokes, not all of the reflected images may be seen at once. This feature adds an aesthetically pleasing visual depth to the look of the wheel.

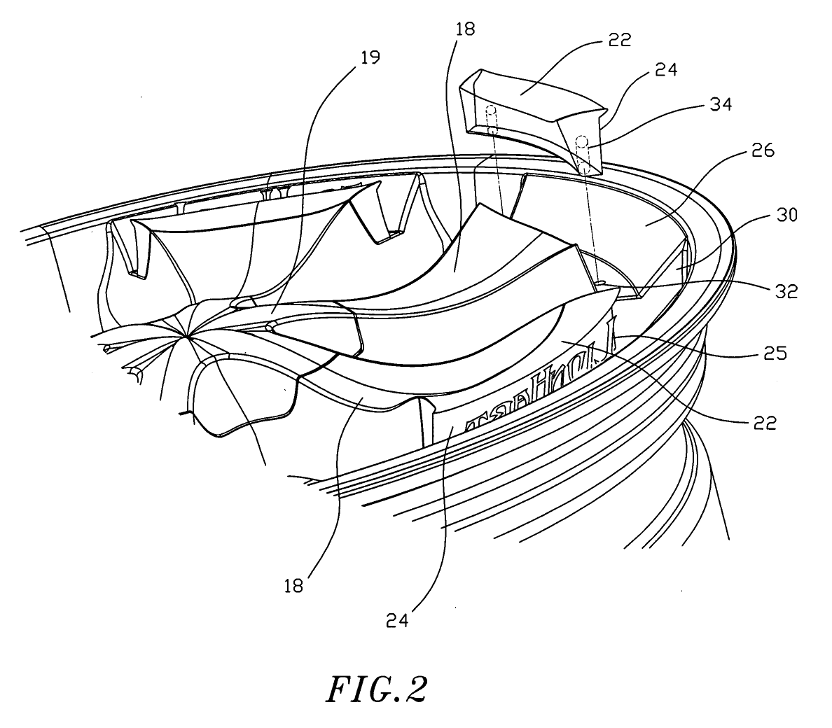

In one embodiment, as shown for example in FIGS. 2 and 3, an end of each spoke 18 includes a valley 30. According to this embodiment, each valley 30 receives a corresponding removable insert 22. In the depicted embodiment, each valley 30 includes one or more valley openings 32 and each insert 22 correspondingly includes one or more insert openings 34, such that when the insert 22 is disposed in the valley 30, the valley opening(s) 32 and the insert opening(s) 34 are aligned.

With the valley and insert openings 32 and 34 aligned, a fastener 36, such as a treaded screw, may be inserted through the openings 32 and 34 to attach the insert 22 to the valley 30 of the spoke 18. In such an embodiment, the insert openings 34 may be internally threaded to engage the threads of the fastener 36 to attach the insert 22 to the spoke 18.

As shown, for example, in FIG. 3, when the insert 22 is attached to the valley 30, the image receiving area 24 of the insert 22 is disposed at a predetermined distance 38 from the image reflecting area 26. In one embodiment, the predetermined distance 38 between the image receiving area 24 of the insert 22 and the image reflecting area 26 is in the range of about ½ inch to about 12 inches. In one particular embodiment, the preferred predetermined distance 38 is from about ½ inch to about 1 inch.

As is also shown in FIG. 3, when the insert 22 is attached to the valley 30, the image receiving area 24 of the insert 22 is disposed at a predetermined angle 40 with respect to the image reflecting area 26. This angle 40 allows the image 25 to be reflected by the image reflecting area 26. In one embodiment, the predetermined angle 40 between the image receiving area 24 of the insert 22 is about 40°.

In one embodiment, in order to optimize the reflection of the image along the line of sight 28 of the viewer, the image reflecting area 26, in addition to being disposed at a predetermined reflecting angle 40 with respect to the image receiving area 24, is disposed at a reflecting angle 42 with respect to the viewer's line of sight 28. In one embodiment, the preferred reflecting angle is about 45°. As shown for example in FIG. 3, in one embodiment the image reflecting area 26 in formed by one of the sides of the valley 30. As such, in this embodiment the image reflecting area 26 is integrally formed on the spoke 18. It should also be recognized that according to this embodiment, the overall geometry of the rim, and in particular, the predetermined angle 40 and the reflecting angle 42 are selected such that from the viewer's line of sight, the image cannot be seen directly, and can only be seen as a reflected view. Such a design provides a particularly pleasing visual effect.

In the depicted embodiment of FIGS. 4A and 4B, the image 25 on the image receiving area 24 of the insert 22 may be disposed on a decal or sticker that is adhesively attached to the image receiving area 24 of the insert 22. In other embodiments, however, the image 25 on the image receiving area 24 of the insert 22 may be integrally formed thereon. Whether provided integrally to the image receiving area, or otherwise affixed to the image receiving area, the image may be a two or three dimensional image to achieve varying visual effects.

As can be seen in FIGS. 4A and 4B, the image 25 on the image receiving area 24 is a mirror or reverse image of what is seen by the viewer. The image reflecting area 26 reflects the image 25 of the image receiving area 24 such that a reverse of the original image (shown as reverse image 25′ in FIGS. 4A and 4B) is the image that is ultimately seen by the viewer. Although, the images 25 and 25′ in the depicted embodiment are illustrated as text images, in other embodiments the images 25 and 25′ may include logos, graphic designs, artistic designs or any combination thereof, which may be in either two or three dimensions. As mentioned above, the image 25 may be integrally formed on the image receiving area 24 of the insert 22, or the image 25 may be a separate component that is attached or mounted to the image receiving area 24 of the insert 22.

In still further embodiments, the image 25 that is either formed by or attached to the image receiving area 24 may be formed an embossed or raised shape, a de-bossed or indented shape, or some other sculpted surface among other appropriate structures.

Although the image receiving area 24 and the image reflecting area 26 in the depicted embodiments are illustrated as having flat surfaces, in other embodiments either or both of the areas 24 and 26 may have flat surfaces, convex surfaces, concave surfaces, contoured surfaces or any combination thereof. Convex, concave and other contoured surfaces on either or both of the image receiving area 24 and the image reflecting area 26 can change the size and/or shape of the image 25 as seen by the viewer to further provide various aesthetically pleasing visual effects.

In one embodiment, in order to enhance the clarity of the image 25′ reflected from the image reflecting area 26, the image reflecting area 26 is composed of a highly reflective material that is capable of reflecting a clear image. Exemplary highly reflective materials include glass, chrome, polished metal or plastic materials. However, aesthetically pleasing effects may also be achieved when the image reflecting area 26 is composed of a less reflective or partially reflective surface.

In the embodiment generally shown in the figures includes an image receiving area 24 is defined by a separate component that is attached to the wheel 10. For example, in the embodiment of FIG. 1, the insert 22 is a separate component that is attached to a corresponding spoke 18 of the wheel 10. It should be noted that the insert 22 and the spoke 18 are shown in the embodiment of FIG. 1, are configured to give the appearance or illusion of being one smooth continuous part. In particular, in the embodiment of FIG. 1, the insert 22 is configured such that when connected to the spoke 18, the outward facing surface 44 of the insert 22 is flush with the outward facing surface 46 of the spoke 18. As is also shown in the embodiment of FIG. 1, the insert 22 may additionally be configured such that when connected to the spoke 18, the side surfaces 48 of the insert 22 are flush with the side surfaces 50 of the spoke 18. This adds to the appearance or the illusion that the insert 22 and the spoke 18 are formed as one continuous part.

However, while the spoke 18 and insert 22 may be configured to look as if they are a single component, they may also be configured to be clearly separate parts. In still further embodiments, the image receiving area 24 may be defined by and/or integrally formed with the wheel 10 rather than being a separate component.

As is also shown in FIG. 1, and perhaps more clearly in FIG. 3, in one embodiment the insert 22 includes a lip 52 that extends from the image receiving area 24 and toward the image reflecting area 26. The lip 52 helps prevent outside objects, such as dust, debris and moisture, from entering the area between the image receiving area 24 and the image reflecting area 26, lowering the probability that outside objects may obscure the view or diminishing the clarity of the image 25′ reflected from the image reflecting area 26. The lip 52 further helps to keep the image from being in the direct view of the viewer such that the only view of the image seen by the viewer is a reflected view. This feature helps to provide the viewer with an aesthetically pleasing depth to the image.

In one embodiment, if desired, the insert 22 is designed to be removed and replaced by another insert 22. Such a replacement may be desirable if the image 25 on the image receiving area 24 of the insert 22 has become distorted, less clear or otherwise damaged, or if the insert 22 itself has become damaged. Furthermore, this allows the owner of the wheel to more easily replace the image or images with new or different images such that the look of the wheel can be easily and inexpensively changed or customized. In an embodiment where the insert 22 is attached to the spoke 18 by the fastener 36 as described above, the insert 22 may be removed by disengaging the fastener 36 from the insert 22. This can be accomplished by reaching into one of the openings 20 that is adjacent to the spoke 18 to which the insert 22 is attached to access and disengage the fastener 36. A replacement insert 22 may than be inserted into the valley 30 of the spoke 18 and the fastener 36 threaded to it to attach the replacement insert 22 to the spoke 18. Other possible means for fixing the insert are well known to those of skill in the art and can even include a friction fit whereby the inserts can be changed in just a few minutes without the need for any elaborate tools.

The wheel 10 is produced by any one of many known methods for making wheels, one example being the use of a casting process. Furthermore, the wheel can be made of any one of several materials well known in the art of wheel building and design. In embodiments where the wheel 10 is composed of a highly reflective material, each image reflecting area 26 may be covered, coated or plated by an appropriate highly reflective material, such as any of those discussed above. For example, each image reflecting area 26 may be plated with a chrome material. In addition, remaining portions of the wheel 10, such as each of the spokes 18 may be covered, coated or plated by an appropriate highly reflective material to produce an overall aesthetically appealing wheel 10. In an alternative embodiment, each image reflecting area 26 may be composed of a polished metal, which is capable of reflecting a clear image. In another embodiment, each insert 22 is composed of a reflective plastic material. In such an embodiment, each insert 22 can be inexpensively produced and therefore inexpensively replaced if necessary.

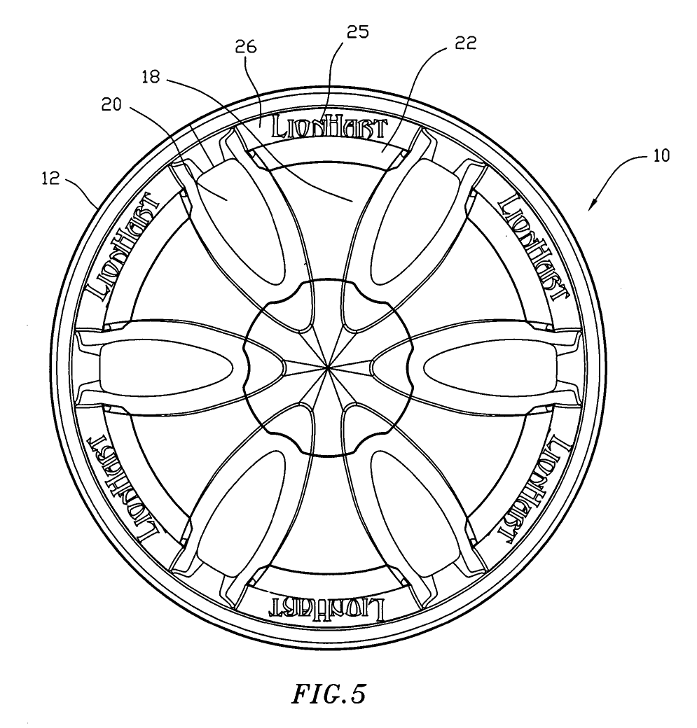

For clarity, FIG. 5 is included to show a front view of the wheel 10 of FIG. 1. This figure shows the view a viewer would see when the wheel 10 is attached to an automobile. As shown, the wheel 10 includes six spokes 18 each having an insert 22 attached thereto and each having an image reflecting area 26 in close proximity to the insert 22. However, in other embodiments, the wheel 10 may have any appropriate number of spokes 18. In addition, in other embodiments every spoke 18 need not have a corresponding insert 18 and/or a corresponding image reflecting area 26. For example, in one embodiment, every other spoke 18 may include a corresponding image receiving area 24 and/or a corresponding image reflecting area 26. Also, although the depicted embodiment shows the inserts 18 and the image reflecting areas 26 as being disposed in closed proximity to an outer periphery of the wheel 10, in other embodiments these elements may be placed at other desired location on the wheel 10. For clarity it is noted the image receiving area 24 may be disposed on and/or defined by other areas of the wheel 10 other than the spoke 18.

Although the above description and illustrations describe embodiments of the wheel of the present invention as being used on an automobile, in other embodiments the wheel according to the present invention may be used on a truck, a trailer, a motorcycle, or any other appropriate vehicle. In addition, it will be appreciated by those of ordinary skill in the art that the invention can be embodied in other specific forms without departing from the spirit or essential character thereof. The present invention is therefore considered in all respects to be illustrative and not restrictive. The scope of the invention is indicated by the appended claims, and all changes that come within the meaning and range of equivalents thereof are intended to be embraced therein.

I claim:

1. A vehicle wheel comprising:
an image receiving area defined by a first surface of the wheel and adapted to receive an image; and
an image reflecting area defined by a second surface of the wheel that is disposed in close proximity to the image receiving area, wherein the image reflecting area reflects the image receiving area into a line of sight of a viewer.

2. The vehicle wheel of claim 1, wherein the image receiving area is disposed at a predetermined distance from the image reflecting area.

3. The vehicle wheel of claim 2, wherein the predetermined distance is in the range of about ½ inch to about 12 inches.

4. The vehicle wheel of claim 1, wherein the image receiving area is disposed at a predetermined angle with respect to the image reflecting area.

5. The vehicle wheel of claim 4, wherein the predetermined angle is about 40°.

6. The vehicle wheel of claim 1, further comprising an integral image.

7. The vehicle wheel of claim 6 wherein the integral image is selected from two and three dimensional images.

8. The vehicle wheel of claim 1 further comprising an image comprising a decal that is adhesively attached to the image receiving area.

9. The vehicle wheel of claim 1, further comprising an image affixed to the image receiving area, wherein the image is an image is selected from the group consisting of text images, logos, graphic designs, and artistic designs.

10. The vehicle wheel of claim 1, wherein the image reflecting area comprises a highly reflective surface.

11. A vehicle wheel comprising:
at least one spoke;
an removable insert attached to the at least one spoke, wherein the insert comprises an image receiving area adapted to receive an image; and
an image reflecting area disposed in close proximity to the image receiving area, wherein the image reflecting area reflects the image receiving area into a line of sight of a viewer.

12. The vehicle wheel of claim 11, wherein the at least one spoke comprises a valley adapted to receive the insert and wherein a portion of the valley forms the image reflecting area.

13. The vehicle wheel of claim 11, wherein the insert is configured such that when the insert is connected to the at least one spoke, an outward facing surface of the insert is substantially flush with an outward facing surface of the at least one spoke and side surfaces of the insert are substantially flush with side surfaces of the at least one spoke.

14. The vehicle wheel of claim 11, wherein the insert includes a lip that extends from the image receiving area and toward the image reflecting area.

15. The vehicle wheel of claim 11, wherein the image receiving area is disposed at a predetermined distance from the image reflecting area.

16. The vehicle wheel of claim 15, wherein the predetermined distance is in the range of about ½ inch to about 12 inches.

17. The vehicle wheel of claim 11, wherein the image receiving area is disposed at a predetermined angle with respect to the image reflecting area.

18. The vehicle wheel of claim 17, wherein the predetermined angle is about 40°.

19. The vehicle wheel of claim 11, further comprising an image disposed on a decal that is adhesively attached to the image receiving area.

20. The vehicle wheel of claim 11, further comprising an integral image

21. The vehicle wheel of claim 20 wherein the integral image is selected from two and three dimensional images.

22. The vehicle wheel of claim 11 further comprising an image selected from the group consisting of text images, logos, graphic designs, and artistic designs.

23. The vehicle wheel of claim 11, wherein the image reflecting area comprises a highly reflective surface.
